(19) United States
(12) Patent Application Publication
(10) Pub. No.: US 2008/0168891 A1
(43) Pub. Date: Jul. 17, 2008

(54) Communication system for water aerobics

(76) Inventor: Felecia Fisehell, Glenelg, MD (US)

Correspondence Address: Felecia Fischell, 4109 Flintlock Ct., Glenelg, MD, 21737, US

(21) Appl. No.: 11/652,448

(22) Filed: Jan. 12, 2007

(51) Int. Cl. G09B 15/00

(52) U.S. Cl. 84/470 R

(57) ABSTRACT

The present invention is a communication system that allows simultaneous music with voice from the instructor both of which come through the student's headphones. The instructor's system has two sources of audio signal that are both inputs into a mixer/amplifier. One source is the instructor's microphone and the other source is a source of the music that is to be heard by the students. The music source could be MP3, CDs or the radio or an iPod, etc. Both the instructor's microphone and the music source are fed into a mixer/amplifier whose output feeds into both the instructor's headset and a transmitter having an antenna that transmits the combined signal to a receiver located in the waterproof headphones used by each student or by a separate receiver that is electrically connected to the student's headphones.

### FIELD OF USE

This invention is in the field of methods and devices for simultaneously providing music and verbal directions from an instructor to a class of individuals exercising in a pool.

### BACKGROUND OF THE INVENTION

Exercising within a pool allows most of the exerciser's weight to be buoyed up by immersion in the water. This can improve the ability of many students, particularly older people and those having some difficulty in moving their arms or legs, to have a beneficial exercise experience. Prior systems have been created that allow the swimmers to hear music from waterproof headphones while exercising but an instructor's voice would not be able to be heard from the headphones but would be heard as speech coming through the air. It would be desirable to have both the music and the instructor's voice be heard by the students by means of their headphones.

### SUMMARY OF THE INVENTION

The present invention is a communication system that allows simultaneous music with voice from the instructor both of which come through the student's headphones. The instructor's system has two sources of audio signal that are both inputs into a mixer/amplifier. One source is the instructor's microphone and the other source is a source of the music that is to be heard by the students. The music source could be MP3, CDs or the radio or an iPod, etc. Both the instructor's microphone and the music source are fed into a mixer/amplifier whose output feeds into both the instructor's headset and a transmitter having an antenna that transmits the combined signal to a receiver located in the waterproof headphones used by each student or by a separate receiver that is electrically connected to the student's headphones. The relative amplitude of the music and the signal from the instructor's microphone are each controlled by volume adjust controls on the headphones and on the music source. The mixer/amplifier can be made to decrease the amplitude of the music when there is a voice signal from the instructor. The degree to which the music signal is attenuated when the instructor is speaking can be adjusted by an adjustment means that is part of the mixer/amplifier.

The signal from the instructor's transmitter is received in the student's system. This receiver could be separate from or made a part of the waterproof headphones worn by the students. The receiver feeds into an amplifier that has a volume control that adjusts the sound level heard by the student. The entire system used by the student must be waterproof to avoid being damaged by the water in which the student is standing.

Thus one object of the present invention is to have a system whereby the instructor's voice and a source of music can each be transmitted by radio to students who are exercising in some body of water.

Another object of this invention is that there is a control within the instructor's system that allows the music level to be attenuated when the instructor is speaking.

Still another object of this invention is that the relative attenuation of the music while the instructor is talking is controllable by the instructor.

These and other objects and advantages of this invention will become obvious to a person of ordinary skill in this art upon reading the detailed description of this invention including the associated drawings as presented herein.

### BRIEF DESCRIPTION OF THE DRAWINGS

FIG. 1 .is a block diagram of the instructor's system.

FIG. 2 is a block diagram of the student's system.

### DETAILED DESCRIPTION OF THE INVENTION

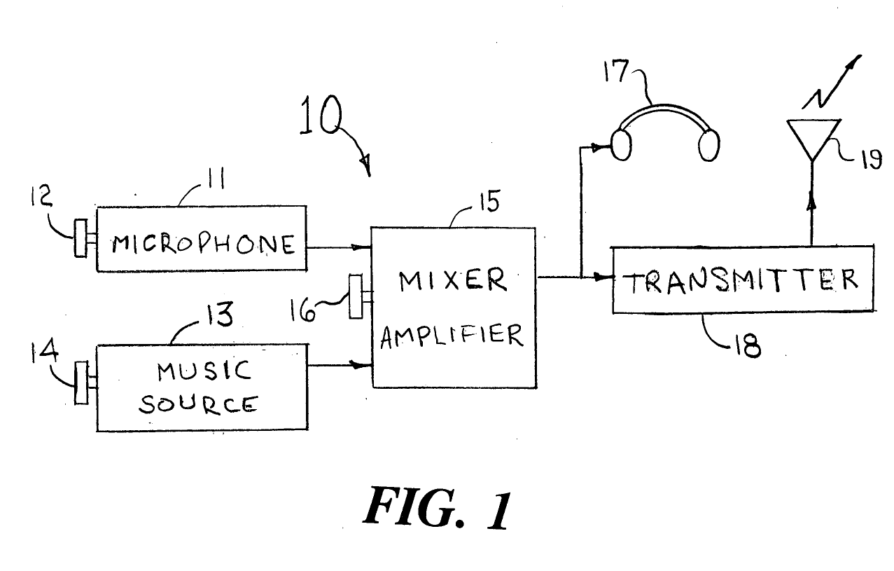

FIG. 1 is a block diagram of the instructor's system 10 having a microphone 11 with an amplitude control 12, a music source 13 having an amplitude control 14, a mixer/amplifier 15 having a control 16, instructor headphones 17 and a transmitter 18 whose output radiates from an antenna 19. The system 10 would typically be on the deck of a pool with the students being in the pool where (typically) they would be able to stand. However, it should be understood that other bodies of water, such as off a quiet beach, could be used for the exercising students. When the music is playing, the instructor can adjust the control 14 to control the loudness of the music by listening with the instructor's headphones 17. When the instructor speaks, he can adjust the control 12 to adjust the loudness of his/her voice. With the control 16 on the mixer/amplifier 15, the instructor can control the relative attenuation of the music when the instructor is speaking. This control could allow the music volume to remain unchanged, could completely attenuate the music to the point where it could not be heard, or could adjust the relative level of voice and music to be anywhere in between.

Because the instructor is in close proximity to water, it would be desirable to have his/her headphones 17 to be waterproof. The transmitter 18 would operate at an amplitude and frequency that is allowed by the Federal Communication Commission for such private purposes.

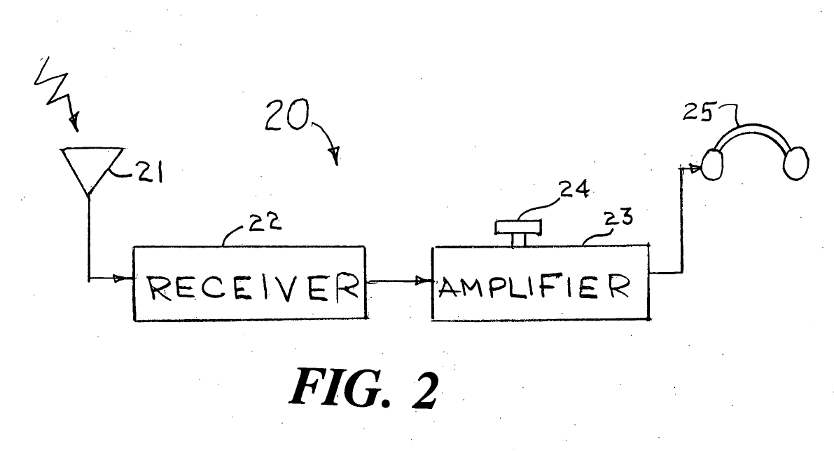

The student's system 20 shown in FIG. 2 would have a receiving antenna 21 that feeds into the receiver 22 whose output is fed into an amplifier 23. The amplifier 23 has a volume control 24 that is adjustable by the student to adjust the sound level as heard with the headphones 25. The receiver 22 could be a separate waterproof device that feeds into a separate waterproof amplifier 23, or either or both the receiver 22 and/or the amplifier 23 could be located within the headphones 25. The receiving antenna 21 could also be a separate structure or it could be attached to or placed within the headphones 25.

Various other modifications, adaptations and alternative designs are of course possible in light of the teachings as presented herein. Therefore it should be understood that, while still remaining within the scope and meaning of the appended claims, this invention could be practiced in a manner other than that which is specifically described herein.

What is claimed is:

1. A system for simultaneously providing music and a voice signal from an instructor by means of wireless communication from the instructor and from a source of music to at least one student, the student receiving the music and voice into a waterproof headset worn by the student.

2. The system of claim 1 where the instructor can adjust the relative amplitude of the music compared to the amplitude of the instructors voice as received in the students headset.

3. The system of claim 1 where the amplitude of the music is automatically reduced whenever there is a voice signal from the instructor.

4. The system of claim 3 where the instructor can adjust the level to which the music level is attenuated when the instructor is speaking.
